(19) United States
(12) Patent Application Publication
(10) Pub. No.: US 2015/0020948 A1
(43) Pub. Date: Jan. 22, 2015

(54) AUTOMATED DETECTION OF URETHANE APPLICATION

(71) Applicant: GM GLOBAL TECHNOLOGY OPERATIONS LLC, DETROIT, MI (US)

(72) Inventors: CRAIG R. STEVENSON, ROMEO, MI (US); DAVID GROLL, ROCHESTER HILLS, MI (US); RAYMOND J. PUDLIK, FARMINGTON HILLS, MI (US); MARK R. SEIPEL, MACOMB, MI (US)

(73) Assignee: GM GLOBAL TECHNOLOGY OPERATIONS LLC, DETROIT, MI (US)

(21) Appl. No.: 14/270,480

(22) Filed: May 6, 2014

Related U.S. Application Data
(60) Provisional application No. 61/847,049, filed on Jul. 16, 2013.

(51) Int. Cl. B62D 65/00; G01N 21/84; C03C 17/32; C03C 17/00; B62D 65/06

(52) U.S. Cl. CPC B62D 65/005; C03C 17/002; B62D 65/06; C03C 17/322; G01N 21/8422; G01N 2021/8427
USPC 156/64; 427/8; 118/712

(57) ABSTRACT

A detection of urethane applied to a workpiece, and more particularly to automated infrared detection of urethane application on a workpiece in order to detect improper application of the urethane.

### CROSS REFERENCE TO RELATED APPLICATIONS

This patent application claims priority to and the benefit of U.S. provisional application No. 61/847,049, filed Jul. 16, 2013, the full disclosure of which is incorporated herein by reference.

### BACKGROUND OF INVENTION

The present invention relates generally to detection of urethane applied to a workpiece, and more particularly to automated infrared detection of urethane application on a workpiece in order to detect improper application of the urethane.

During installation of a fixed window, such as a windshield or backlight, during a vehicle assembly process at an assembly plant, an automated process may be employed to apply a bead of urethane around a perimeter of the window. The window is then mounted to vehicle structure, which may be accomplished manually or by a robot, within a short period of time. The urethane then bonds to the structure. This assembly process is used in order to both secure and seal the perimeter of the glass to the structure. When installed properly, the urethane with provide a water tight seal around the entire periphery and ensure window retention that meets motor vehicle requirements.

If, however, the urethane application is not adequate, the potential for leaking or less than desirable bonding strength may result. Thus, some have attempted to employ an automated process that inspects the urethane immediately after application and before mounting to the vehicle. Such an inspection system has included a mechanical device that moves along the urethane bead and uses a light beam and sensors to try and detect proper/improper bead application. However, this type of system has generally been prone to maintenance issues due to urethane getting onto and blocking the sensors, cable wear issues due to the movement around the perimeter of each window pane as the inspection takes place, vehicle sensing systems already mounted to the glass being in the way, and interference issues due to curvature of the window pane. Also, moving a sensor along the entire bead length may take more time than is desired during an assembly process.

Additionally, in general, visual inspections of urethane application to automotive glass is not particularly feasible due to a lack of visual contrast between the urethane and the glass. This lack of contrast between the urethane employed and the glass is intentional to avoid aesthetic issues for vehicle occupants.

### SUMMARY OF INVENTION

An embodiment contemplates a method of urethane application to a workpiece, comprising the steps of: applying a bead of urethane onto a predetermined location of a surface of the workpiece; orienting the surface toward an infrared detector; generating an infrared image of the surface and the bead; and determining whether the bead application meets a predetermined requirement.

An embodiment contemplates a system for urethane application on a workpiece. The system may include a robot configured that secures the workpiece for urethane application, a urethane applicator that applies a bead of urethane to the workpiece, an infrared detector that creates an infrared image of the workpiece after urethane application, and a controller that determines whether the bead application meets a predetermined requirement.

An advantage of an embodiment is that automated inspection of urethane application around a perimeter can be accomplished quickly and easily, and without encountering maintenance or interference concerns. With the quick and accurate inspection, improper urethane applications can be detected and corrected, thus insuring window mounting that minimizes the potential of water leaks and ensures proper bonding strength of the window to structure. Inspection and correct installation the first time may also save on overall costs of vehicle assembly.

An additional advantage of an embodiment is that the automated inspection of urethane application may allow for greater product variation in the shapes of windows being installed and require less maintenance of the inspection system.

Also, the bead inspection may be conducted after a complete dispense cycled (i.e., after a bead has been placed around the entire perimeter of the glass), which may increase the accuracy in detecting bead application failures.

Moreover, the infrared detector may be stationary and spaced from the urethane dispensing hardware, thus reducing the risk of contamination of the sensor.

### BRIEF DESCRIPTION OF DRAWINGS

FIG. 1 is a schematic view of a urethane application and detection system, and a window having a fresh application of urethane around the perimeter of the window supported by a robot, prior to mounting of the window to structure.

FIG. 2 is a schematic view of a thermal image of the window with a fresh application of urethane around the perimeter of the window, prior to mounting of the window to structure.

FIG. 3 is a schematic view of a processed thermal image of a fresh urethane application around the perimeter of the window, with defective urethane application illustrated, prior to mounting the window to structure.

FIG. 4 is a schematic view of the window mounted to structure, such as a vehicle structure.

### DETAILED DESCRIPTION

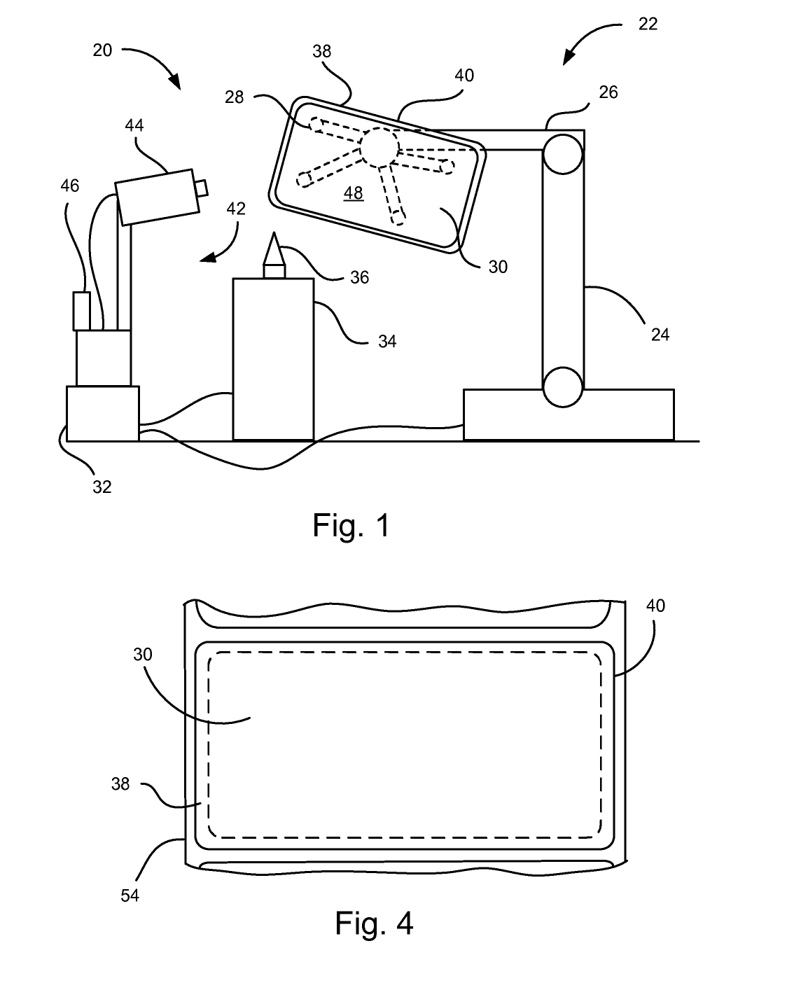

FIG. 1 schematically illustrates a urethane application and detection system 20. A robotic portion 22 of the system 20 may include a robot 24 having an arm 26 that has support members 28, such as suction cups, for temporarily securing, lifting and moving a workpiece 30, such as a window. The robot 24 may be controlled by a controller 32. This robotic portion 22 of the system 20, and its control, may be conventional, if so desired, and so will not be discussed in more detail herein. The workpiece 30 may be, for example, a windshield, backlight or other fixed window that mounts to vehicle structure.

The system 20 also may include a urethane applicator 34, with a nozzle 36 for dispensing urethane 38 around a periphery 40 of the workpiece 30. The applicator 34 may be controlled in coordination with the robot 22 for application of the urethane 38 to the workpiece 30. This applicator 34 and its control may also be conventional, if so desired, and so will not be discussed herein in more detail.

The system 20 may also include an infrared detection portion 42, which may be in communication with the controller 32. This controller may be a single controller or multiple controllers in communication with one another, and may be made up of various combinations of hardware and software as is known to those skilled in the art. The detection portion 42 may include an infrared camera 44 that is in the general area where the urethane 38 is applied. The camera 44 is preferably located at a position where the robot 24 can lift the workpiece 30, immediately after the urethane 38 is applied, and orient the face with the urethane applied toward the camera 44. The camera 44 is in communication with the controller 32 so that the infrared images will be received by the controller 32. The controller 32 and/or the infrared detection portion 42 include an output device 46, where the results of an infrared scan of the urethane 38 are communicated to a worker in the assembly facility. This output device 46 may communicate visually, audibly or both to indicate the status of urethane application and inspection.

The operation of the urethane application and detection system 20 will now be discussed with reference to FIGS. 1-3. In this discussion, the workpiece 30 is a window that is being installed onto vehicle structure. The robot 24 moves the arm 26 so that the suction cups 28 are pressed against the window 30, and activated to adhere to the window 30. Other mechanisms for securing the window 30 may be used instead of suction cups, if so desired. The window 30 is then lifted and moved to the urethane applicator 34.

At this point, the arm 26, the applicator 34, the applicator nozzle 36, or some combination of the three are moved relative to each other so that urethane 38 is dispensed as the nozzle 36 travels around the periphery 40 of the window 30 to form a bead. That is, depending upon the desired setup of the system, the urethane applicator 34 may moved relative to the window 30 while the window 30 is held stationary, the robot 24 may move the window 30 relative to a stationary urethane applicator 34, or the two may move relative to each other during the urethane application process.

The arm 26 then raises the glass 30 and faces the surface 48 of the glass 30 having the urethane 38 applied to it toward the infrared camera 44. This system 20 allows the infrared camera 44 to be stationary, if so desired. Preferably, this orientation toward the camera 44 occurs within about thirty seconds from finishing the application of the urethane 38. This is because the application process results in the urethane 38 rising in temperature above room temperature, which is approximately the temperature of the glass 30. But the longer the urethane 38 is on the glass 30 before taking an infrared image, the closer the urethane 38 will be to room temperature, thus reducing the contrast in the infrared image between the urethane 38 and the glass 30. This initial temperature difference may be, for example, about thirty degrees Fahrenheit (seventeen degrees C.) above room temperature.

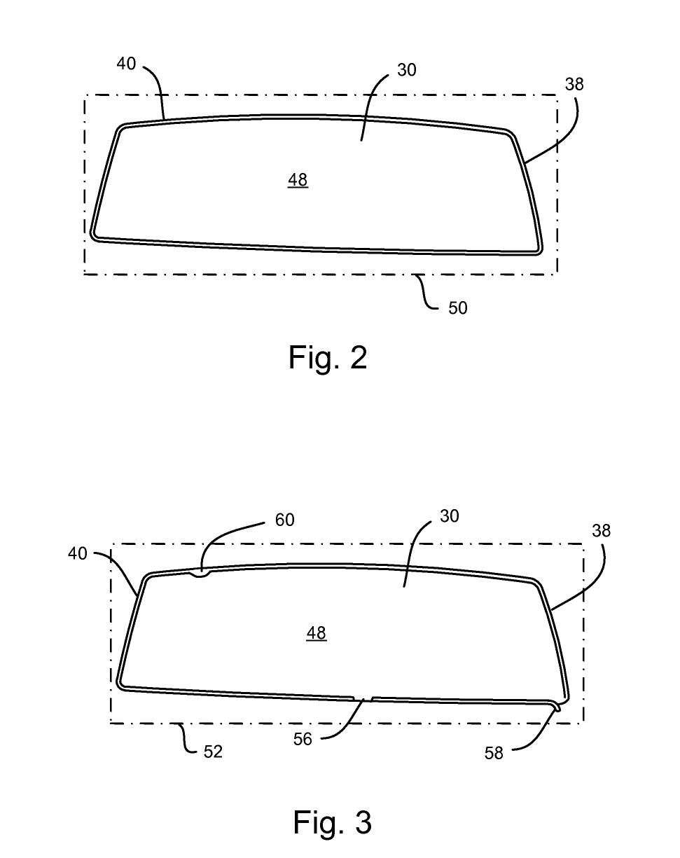

The camera 44 takes an infrared image 50, illustrated in FIG. 2, of the glass 30 with applied urethane 38 and communicates this image to the controller 32. The higher temperature urethane 38 will appear distinct from the generally room temperature glass 30 in the image, which may appear as light areas (urethane) and dark areas (room temperature window and surroundings) in the infrared image. The controller then analyzes the image 50 to detect whether the application has been acceptable or is defective.

FIG. 2 shows the infrared image 50 with a continuous, relatively uniform width bead of urethane 38 around the periphery 40 of the window 30. This image shows the acceptable (desired) bead of urethane 38 for sealing and securing the window 30. The specific contours, width and shape of the acceptable urethane bead 38 may vary from one particular size and shape of window to the next, but an acceptable bead uniformity and continuity for proper application sealing and securement is known to those skilled in the art.

FIG. 3 shows an image 52 with a defective (unacceptable) urethane bead 38 around the periphery 40 of the window 30, where the bead application does not meet a predetermined requirement. For example, there may be a gap 56 in the urethane bead 38 (not continuous), or a gap with a tail 58 where the urethane bead 38 is drooping down off of the window 30 (not continuous and bead is off-path), or a smudge (blotch) 60 where there is either too much urethane or it has been smeared away from the periphery 40 of the window 30 (too wide), thus not meeting one or more of these predetermined requirements. These are just examples, as there may be other predetermined requirements for conformity of the bead to assure the desired adhesion and/or sealing. Thus, for example, dark areas show up in the thermal image where urethane (light areas) should appear, or light areas that are too wide. Again, the specific contours, width and shape of the defect(s) that indicate a defective urethane bead 38 may vary from one particular size and shape of window to the next, but an acceptable bead uniformity and continuity for proper application sealing and securement is known to those skilled in the art.

The infrared camera 44 provides the infrared image quickly, and this image accurately detects the size, shape and continuity of the particular bead 38 on its corresponding window 30. This allows for quick automated determination of whether the urethane bead application is acceptable or defective. For example, the robotic process and thermal camera inspection may take as little as two seconds to inspect the urethane bead 38.

Also, during this process, the infrared camera 44 may be maintained at a distance from the window 30 that is substantial enough to avoid the potential for urethane to get onto the camera itself. This may minimize potential downtime for cleaning of the inspection equipment. Also, by maintaining this distance, the camera 44 can take an infrared image that encompasses the whole window 30 and bead 38 in just that one image, allowing for full analysis of the bead in one image, while also minimizing inspection time. This also allows for easy adaption for inspection of different sized and shaped windows since the camera 44 may be located at a distance during inspection.

As illustrated in FIG. 4, if the urethane application is detected as acceptable, then the arm 26 moves the glass 30 into position for either automated or manual installation of the glass 30 onto a structure, such a vehicle structure 54. At this point, the urethane 38 then bonds to the structure 54 to both seal around the periphery and secure the glass 30 to the structure 54.

If the urethane application is detected as not acceptable, then some type of error message may be communicated by the output device to the assembly worker. This worker may then take appropriate steps to assure that a window 30 with a defective urethane bead application is not mounted to the vehicle structure 54, and to perform maintenance on the system 20 as needed to correct the error.

While certain embodiments of the present invention have been described in detail, those familiar with the art to which this invention relates will recognize various alternative designs and embodiments for practicing the invention as defined by the following claims.

1. A method of urethane application to a workpiece, comprising the steps of:
(a) applying a bead of urethane onto a predetermined location of a surface of the workpiece;
(b) orienting the surface toward an infrared detector;
(c) generating an infrared image of the surface and the bead; and
(d) determining whether the bead application meets a predetermined requirement.

2. The method of claim 1 wherein the infrared detector is an infrared camera, which generates the infrared image.

3. The method of claim 1 wherein the workpiece is a window and step (a) includes applying the bead of urethane around a periphery of the window.

4. The method of claim 3 further including, when the bead application is determined in step (d) to meet a predetermined requirement, installing the window onto a structure by pressing the bead against the structure.

5. The method of claim 4 wherein the structure is a vehicle structure, and the window is secured to the vehicle structure.

6. The method of claim 1 wherein step (a) includes a robot automatically securing the workpiece, and the robot and a urethane applicator moving relative to each other during application of the bead.

7. The method of claim 6 wherein step (b) includes the robot moving the workpiece in front of the infrared detector.

8. The method of claim 1 wherein steps (b) and (c) occur within about thirty seconds of step (a).

9. The method of claim 1 wherein step (a) includes the predetermined location being about a periphery of the surface of the workpiece, and step (d) includes determining the bead application does not meet the predetermined requirement when a gap in the bead occurs as the bead extends about the periphery.

10. The method of claim 1 wherein step (a) includes the predetermined location being about at least a portion of a periphery of the surface of the workpiece, and step (d) includes determining the bead application does not meet the predetermined requirement when a width of the bead at a location along the bead is wider than a predetermined width.

11. The method of claim 1 wherein the infrared detector is stationary during steps (b) and (c).

12. The method of claim 1 further including, when the bead application is determined in step (d) to not meet a predetermined requirement, signaling a defective bead application with a human interface output device.

13. A system for urethane application on a workpiece comprising:
a robot configured to secure the workpiece for urethane application;
a urethane applicator configured to apply a bead of urethane to the workpiece;
an infrared detector configured to create an infrared image of the workpiece after urethane application; and
a controller configured to determine whether the bead application meets a predetermined requirement.

14. The system of claim 13 wherein the infrared detector is stationary and the robot is configured to move the workpiece after urethane application to face a surface of the workpiece with the applied urethane bead facing toward the infrared detector.

15. The system of claim 13 wherein the robot and the urethane applicator are configured to move relative to each other during application of the urethane.

16. The system of claim 13 wherein the infrared detector is an infrared camera.

17. The system of claim 13 wherein the system includes a human interface device configured to signal a defective urethane application when the bead application does not meet the predetermined requirement.

18. The system of claim 13 wherein the urethane applicator is configured to apply the bead of urethane around a periphery of the workpiece, and the controller is configured to detect that the bead application fails the predetermined requirement when a gap in the bead occurs as the bead extends around the periphery.

19. The system of claim 13 wherein the urethane applicator is configured to apply the bead of urethane around a periphery of the workpiece, and the controller is configured to detect that the bead application fails the predetermined requirement when a width of the bead at a location along the bead is wider than a predetermined width.

20. The system of claim 13 wherein the urethane applicator is configured to apply the bead of urethane around a periphery of the workpiece, and the controller is configured to detect that the bead application fails the predetermined requirement when the bead extends in a direction other than around the periphery of the workpiece.
